(19) United States
(12) Patent Application Publication
(10) Pub. No.: US 2003/0007839 A1
(43) Pub. Date: Jan. 9, 2003

(54) Strake receptor for a pipe

(76) Inventor: Andrew Brown, London (GB)

Correspondence Address: NIXON & VANDERHYE, P.C., 8th Floor, 1100 North Glebe Road, Arlington, VA, 22201, US

(21) Appl. No.: 10/124,724

(22) Filed: Apr. 18, 2002

(30) Foreign Application Priority Data
Jul. 6, 2001 PCT/GB01/03040

(51) Int. Cl. E02D 5/60; E02D 31/00; F15D 1/10

(52) U.S. Cl. 405/211; 405/216; 114/243

(57) ABSTRACT

A strake receptor (24) for a pipe deployed from an off-shore lay vessel comprises a formation (27) for engagement with the strake (29) and for deployment on the pipe when the pipe is received in pipe handling equipment located on the vessel. A removable dust cover protects the channel (25) until the strake (29) is received in the channel (25).

This invention relates to a strake receptor for a pipe deployed from an off-shore lay vessel.

When a fluid flows around a bluff body, such a pipe, the flow separates and rolls up into vortices which, after a period of growth, are shed and move downstream to form a periodic wake. The fundamental cause of vortex shedding is dry layer separation which is the result of fluid friction and adverse pressure gradient caused by the flow over the body. The period shedding of vortices creates an asymmetric and periodic pressure distribution around the body, with components in-line and perpendicular to the fluid flow. If the body is sufficiently flexible and has a natural frequency which is close to the frequency of vortex shedding, the periodic pressure distribution causes the structure to vibrate. The vibration, referred to as vortex induced vibration, can lock-on to the structure's natural frequency and become self sustaining.

Vortex induced vibration can lead to large amplitudes of motion and severe cyclical stress in the affected structure which can cause failure through fatigue. Under these conditions there is a large increase in the steady state drag coefficient which can cause other operational problems.

One method of reducing vortex induced vibration is to deploy a certain configuration of strakes on the surface of the body.

However, a problem associated with the deployment of strakes on external surfaces of pipes is that, where pipes and pipelines have been reeled on-shore and laid off-shore, it is necessary to direct the pipes through straightening and tensioning apparatus which apply reverse curvature to the pipes to counter-act the curvature resulting from the reeling process. Since the apparatus engages firmly with an outer surface of a pipe, strakes can only be applied after the pipe passes through the apparatus. Generally, attachment of strakes to a pipe after it has passed though such apparatus is a cumbersome and hazardous procedure.

The same problems arise with apparatus which deploys from a lay vessel pipe which has not been reeled since it is still necessary to feed the pipeline through tensioning apparatus which grips the outer surfaces of the pipeline.

According to the present invention, there is provided a strake receptor for a pipe deployed from an off-shore lay vessel, the receptor comprising a formation for engagement with the strake and for deployment on the pipe when the pipe is received in pipe handling equipment located on the vessel.

Therefore, a strake receptor in accordance with the present invention provides a facility whereby pipes and pipelines may be provided with strakes on-shore and may be subsequently deployed from an off-shore lay vessel without pipe handling equipment located on the vessel interfering with the strakes.

The invention thus provides considerable cost saving because most of the preparatory work can be carried out on-shore.

Following is a description, by way of example only and with reference to the accompanying drawings, of one method of carrying the invention into effect.

In the drawings:

FIG. 1 is an elevation of a pipeline section having strakes deployed thereon,

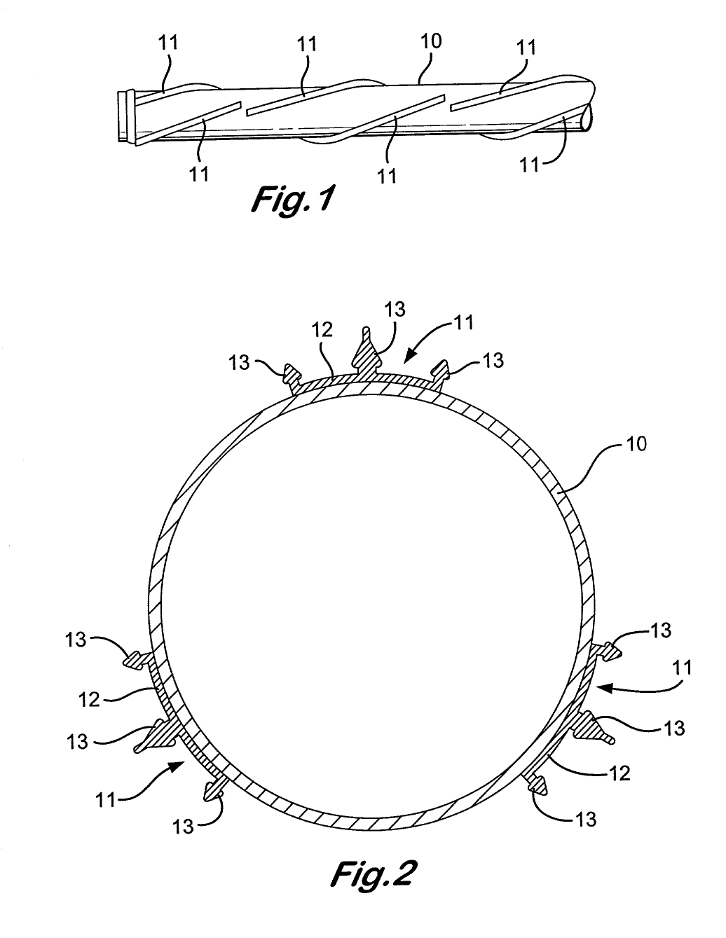

FIG. 2 is a transverse cross section of a pipe having strakes deployed thereon,

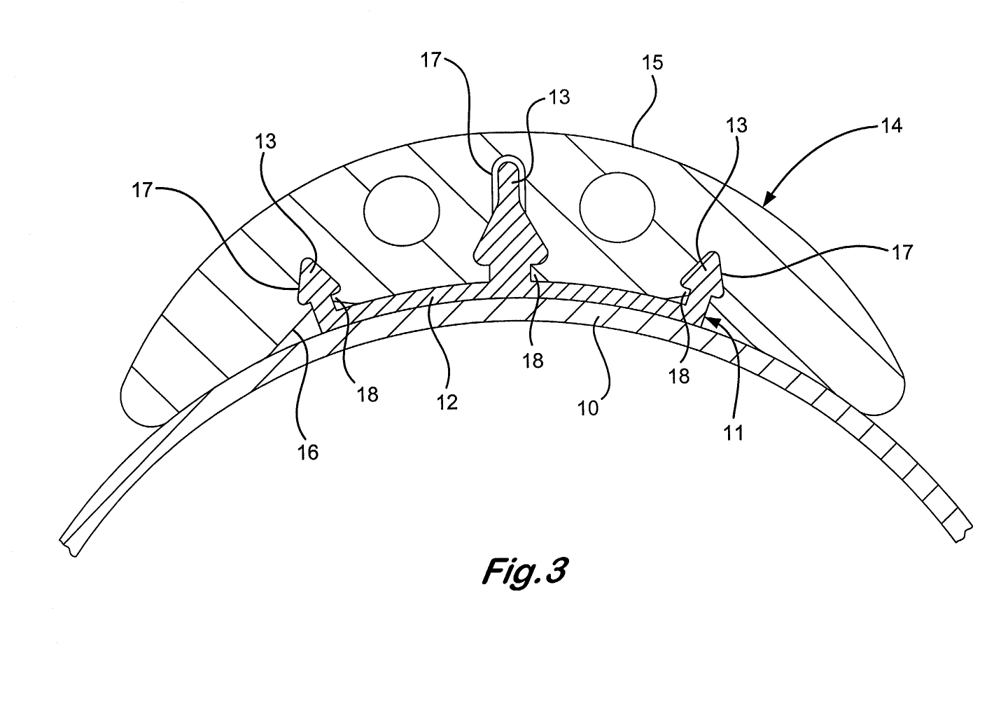

FIG. 3 is a transverse cross section of a portion of a pipe having a strake deployed thereon and having in engagement therewith an embodiment of a receptor in accordance with the present invention,

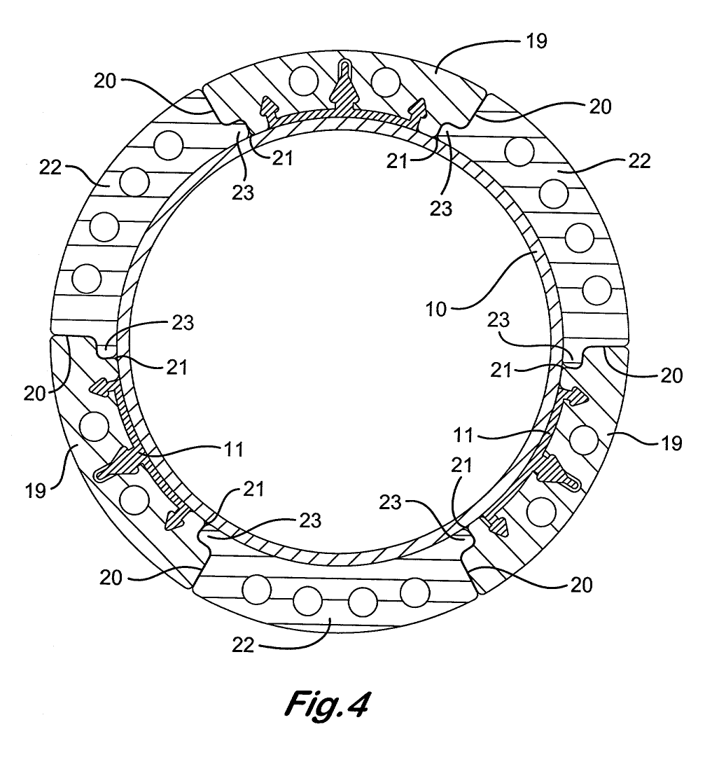

FIG. 4 is a transverse cross section of an oil pipe having a plurality of strakes deployed thereon and having in engagement therewith receptors in accordance with another embodiment of the invention,

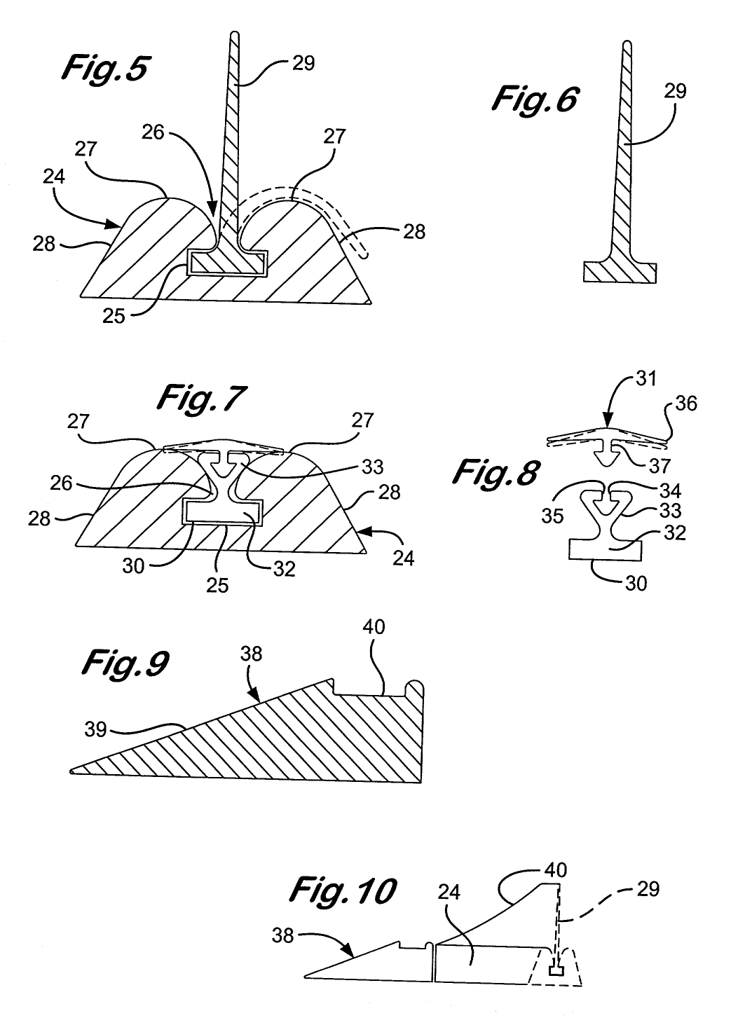

FIG. 5 is a transverse cross section of another embodiment of a receptor in accordance with the present invention having a strake in engagement therewith,

FIG. 6 is a transverse cross section of a strake shown in FIG. 5,

FIG. 7 is a transverse cross section of the receptor shown in FIG. 5 having a temporary insert located therein and a dust cover engaged by the temporary insert,

FIG. 8 is a diagrammatic representation showing the temporary insert and the co-operating dust cover,

FIG. 9 is a longitudinal cross- section of a guide ramp and

FIG. 10 is a diagrammatic representation of the guide ramp and a receptor located in association therewith.

Referring now to FIGS. 1 and 2 of the drawings, there is shown a pipe 10 having strakes 11 deployed thereon and extending in helical configuration longitudinally of the pipe 10. The pipe 10 is formed of steel and the strakes 11 are formed of rubber, or other compliant material, and are adhesively bonded to an outer surface of the pipe 10. Each strake 11 comprises a flange portion 12 and one or more radially outwardly extending longitudinal projections 13 of substantially arrow head configuration in transverse cross section, the apeces of which are remote from the flange 12.

Referring now to FIG. 3 of the drawings, there is shown an embodiment of a receptor 14 in accordance with the present invention. The receptor 14 is formed of resilient material, such as rubber and has an arcuate outer surface 15 and a concave inner surface 16. The concave inner surface 16 is provided with recesses 17 each for receiving a corresponding one of the projections 13. Each of the recesses 17 is provided with a constriction 18 for snap engagement under the arrow head configuration of each corresponding projection 13 when received in the corresponding recess 17.

The arrangement is such that the receptor 14 is connectable by snap engagement with a strake 11 and the material of the receptor 14 is such that the receptor 14 may easily be flexed so as to disengage with the strake 11.

Provision of the receptor 14 in engagement with a strake 11 ensures protection of the strake 11, when located on a pipe 10, when the pipe 10 is fed through pipe handling equipment, for example for straightening a tube after is has been reeled or for feeding a tube from a lay vehicle.

Such strake receptors provide a facility whereby pipes may be provided with strakes at an on-shore location and may then be transported off-shore to a lay vessel.

Referring now to FIG. 4 of the drawings, there is shown a pipe 10 having a plurality of strakes 11 carried thereon and a plurality of receptors 19 each in engagement with a corresponding one of the strakes 11. The receptors 19 are similar to the receptors 14 except that longitudinal side faces extending in a direction radially outwardly from the pipe 10 are each provided with a lower recess 21. The receptors 14 are intended for co-operation with intermediate arcuate spacers 22 each of which are provided with longitudinal projections 23 for engaging under the longitudinal side edges 20 of the receptors 19. The arrangement is such that the spacers 22 connect with the receptors 19 to form a circumferential protecting shield for the pipe 10 when the pipe 10 passes through pipe handling equipment.

Referring now to FIGS. 5 to 10 of the drawings, there is shown a further embodiment of a receptor 24 in accordance with the present invention. The receptor 24 comprises a recess 25 of substantially rectangular configuration and having a restricted opening 26, opposite facing walls of the opening 26 curving upwardly and outwardly away from one another into two longitudinal arcuate formations 27 extending into outwardly downwardly sloping side walls 28.

The receptor 24 differs from the receptors 14 and 19 in that the receptor 24 is bonded to an outer surface of a pipe 10 and a strake 29 is subsequently connected thereto.

The strake 29 is of substantially inverted “T” transverse cross section in which the substantially rectangular head formation is received in the rectangular recess 25 of the receptor 24 by longitudinally sliding the strake 29 therein. The strake 29 is of material which is sufficiently flexible such as to flex towards the arcuate and rectilinear surfaces 27, 28 of the receptor 24, when a pipe 10 having the receptor 24 and the strake 29 carried thereon is directed through pipe handling equipment, as shown in chain dotted lines in FIG. 5.

Receptors 24 may be stored separately from the strakes 29 and, in order to ensure that the recesses 25 of the receptors 24 remain dust free, cooperating inserts 30 and dust covers 31 may be provided. Each temporary insert may comprise a base portion 32, of substantially rectangular transverse cross section, and a contiguous upwardly extending bifurcated portion 33 having resilient jaws 34, 35. Each dust cover 31 comprises an elongate cap portion 36 having a central depending web 37 of downwardly extending arrow head configuration in transverse cross section.

The arrangement is such that a temporary insert 30 may be located in a receptor 24 by sliding the insert 30 longitudinally of the recess 25 of the receptor 24. A dust cover 31 then is placed on the receptor 24 and pushed downwardly so that the arrow head configuration of the downwardly extending web 37 of the cover 31 snap engages under the jaws 34, 35 of the temporary insert 30.

When it is necessary to provide the receptor 24 with a strake 29, the procedure is repeated in reverse so that the temporary insert 30 and the co-operating dust cover 31 are removed from the receptor 24.

The temporary insert 30 and dust cover 31 provide two distinct functions.

The temporary insert 30 is designed to prevent any permanent distortion to the lower channel slot 25 due to excess pressure from the handling equipment or rough handling during transit. Also it keeps the channel slot 25 clear of debris during this period which could interfere with the withdrawal and subsequent insertion of the strake 29.

The upper dust cover 31 is made of a softer material that will deform and form a seal at the shoulder locations 27 of the receptor 24, further protecting the channel slot 25 from dirt ingress.

The reason for two different materials is that they fulfil two different functions and so that when the process of withdrawal is taking place the dust cover 31 is removed in an outwards direction, thus making for an easier exit of the temporary insert 30 due to a reduced contact area.

The receptor 24 may be provided with an additional guide ramp 38, as shown in FIGS. 9 and 10, for smoothing inter engagement of the receptor 24 and pipe handling equipment. The guide ramp 38 comprises a forward upwardly inclined ramp 39 and a recess 40 for receiving a strap (not shown) for securing the guide ramp 38 to the pipe 10. The strake 29 may also be provided with a forward leading edge 41 which is inclined in an upward direction away from the guide ramp 38, as shown in FIG. 10.

1. A strake receptor for a pipe deployed from an off-shore lay vessel, the receptor comprising a formation for engagement with the strake and for deployment on the pipe when the pipe is received in pipe handling equipment located on the vessel.

2. A receptor as claimed in claim 1 wherein the formation comprises a recess adapted to receive the strake.

3. A receptor as claimed in claim 2 wherein the recess comprises a cavity and a constriction in a direction outwardly of the cavity.

4. A receptor as claimed in claim 1 wherein the receptor is adapted to engage with other components for forming an annulus around the pipe.

5. A receptor as claimed in claim 3 wherein the configuration of the cavity is such that, in use, the direction outwardly of the cavity is a direction radially outwardly from the pipe.

6. A receptor as claimed in claim 5 wherein the formation is of a configuration such as to provide a pair of opposed outwardly extending curves outwardly of the constriction.
